(19) United States
(12) Patent Application Publication
(10) Pub. No.: US 2025/0258309 A1
(43) Pub. Date: Aug. 14, 2025

(54) SYSTEMS AND METHODS FOR ACQUIRING SEISMIC DATA

(71) Applicant: SAUDI ARABIAN OIL COMPANY, Dhahran (SA)

(72) Inventors: Mohammed SAIT, Thuwal (SA); Charles SEXTON, Thuwal (SA); Raed ALAHMDI, Thuwal (SA)

(73) Assignee: SAUDI ARABIAN OIL COMPANY, Dhahran (SA)

(21) Appl. No.: 18/441,825

(22) Filed: Feb. 14, 2024

(51) Int. Cl. E21B 47/095; E21B 7/06; E21B 44/00; E21B 47/13

(52) U.S. Cl. CPC G01V 1/168; E21B 47/095; E21B 47/14; G01V 2210/66

(57) ABSTRACT

In some examples, a computer-implemented method for a self-burrowing seismic-sensing tool includes determining a course to a target destination within a subsurface formation from a surface location, operating a burrowing device to the target destination based on the course, and generating seismic data based on seismic waves received at the target destination.

### FIELD OF THE DISCLOSURE

The present description relates generally to acquiring seismic data.

### BACKGROUND OF THE DISCLOSURE

Directional drilling is a practice of drilling non-vertical wellbores in a subsurface formation. To maximize reservoir contact, drilling plans for directional drilling operations may use formation models. A formation model enables visualization of the subsurface formation, which may include one or more different sedimentary layers including one or more resource deposits. The formation model may be generated using time-domain data, such as seismic data.

To capture the time-domain data, sources (e.g., seismic vibrators, explosions, acoustic sources) are activated at different locations relative to the subsurface formation. A source at a location generates sonic waves, acoustic waves, or a combination thereof, that propagate toward and through the subsurface formation. The velocity of a wave depends on properties of the subsurface formation (e.g., density, porosity, fluid content). Different sedimentary layers of the subsurface formation have different properties, resulting in different velocities. The waves are reflected back toward the surface when a boundary between two sedimentary layers having different properties is encountered. The reflected waves are received by one or more sensors (e.g., a geophone, a hydrophone, a seismic detector, a sensor for measuring seismic energy or vibrations). The time-domain data is then converted to depth-domain data to generate the formation model, or structural map, of the different sedimentary layers. The formation model may be used to identify impermeable sedimentary layers and faults that may trap hydrocarbons such as oil and gas.

### SUMMARY OF THE DISCLOSURE

Various details of the present disclosure are hereinafter summarized to provide a basic understanding. This summary is not an exhaustive overview of the disclosure and is neither intended to identify certain elements of the disclosure, nor to delineate the scope thereof. Rather, the purpose of this summary is to present some concepts of the disclosure in a simplified form prior to the more detailed description that is presented hereinafter.

According to an embodiment of the present disclosure, a self-burrowing seismic-sensing tool includes a navigator, implemented by a processor, configured to determine a course to a target destination within a subsurface formation, the course being based on a current location received from one or more sensors, a burrower, implemented by the processor, configured to operate a burrowing device to reach the target destination based on the course, and a data acquisition unit, implemented by the processor, configured to generate seismic data based on seismic waves received at the target destination.

According to another embodiment of the present disclosure, a computer-implemented method for a self-burrowing seismic-sensing tool is disclosed and includes determining a course to a target destination within a subsurface formation from a surface location, operating a burrowing device to the target destination based on the course, and generating seismic data based on seismic waves received at the target destination.

According to another embodiment of the present disclosure, a computer-readable medium storing computer-executable instructions is disclosed and, which, when executed by a processor, causes the processor to determine a course to a target destination within a subsurface formation, the course based on a current location received from one or more sensors, operate a burrowing device to the target destination based on the course, and collect seismic data based on seismic waves received at the target destination.

Any combinations of the various embodiments and implementations described herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is a schematic diagram of an example system for acquiring seismic data using a self-burrowing seismic-sensing tool, in accordance with certain embodiments.

FIG. 2 is a block diagram of an example system for acquiring seismic data using a self-burrowing seismic-sensing tool, in accordance with certain embodiments.

FIG. 3 is a flow diagram of a method for acquiring seismic data using a self-burrowing seismic-sensing tool, in accordance with certain embodiments.

FIG. 4 is a block diagram of a self-burrowing seismic-sensing tool, in accordance with certain embodiments.

FIG. 5 is a flow diagram of an example method for acquiring seismic data using a self-burrowing seismic-sensing tool, in accordance with certain embodiments.

FIG. 6 is a schematic diagram of a self-burrowing seismic-sensing tool navigating a subsurface formation, in accordance with certain embodiments.

FIG. 7 is a flow diagram of an example method for acquiring seismic data using a self-burrowing seismic-sensing tool, in accordance with certain embodiments.

FIG. 8 is a flow diagram of an example method for acquiring seismic data using a self-burrowing seismic-sensing tool, in accordance with certain embodiments.

FIG. 9 is a schematic diagram of a self-burrowing seismic-sensing tool navigating a subsurface formation, in accordance with certain embodiments.

FIG. 10 is a flow diagram of an example method for acquiring seismic data using a self-burrowing seismic-sensing tool, in accordance with certain embodiments.

FIG. 11 is a flow diagram of an example method for delivering a self-burrowing seismic-sensing tool, in accordance with certain embodiments.

FIG. 12 is a block diagram aerial view of a plurality of self-burrowing seismic-sensing tools located within a subterranean formation, in accordance with certain embodiments.

FIG. 13 is a flow diagram of an example method for retrieving a self-burrowing seismic-sensing tool, in accordance with certain embodiments.

FIG. 14 is block diagram of a computer system used in accordance with certain embodiments.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments described herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments of the present disclosure relate generally to acquiring seismic data. Seismic acquisition using land surveys involves placing one or more sensors on the surface of a subsurface formation to collect seismic data. Seismic data enables imaging, or modeling, of the subsurface formation for purposes such as resource exploration or geological mapping. The one or more sensors may be geophones, hydrophones, seismic detectors, or other like sensors for measuring sonic or acoustic energy or vibrations. Sonic and acoustic energy vibrations are collectively herein referred to as “seismic waves”. To generate seismic waves, sources are activated at different surface locations. The sources may be seismic vibrators, explosions, acoustic sources, or other like devices for generating seismic waves. As described above, the seismic waves are reflected back toward the surface when a boundary between two sedimentary layers having different properties is encountered, and the reflected waves are received by the one or more sensors.

The survey area may cover large areas. The one or more sensors are to be positioned across the survey area at a plurality of locations that ensure an accuracy and resolution of the seismic data collected. The plurality of locations may form a grid pattern across a survey area with a specified spacing between the one or more sensors. The specified spacing may depend upon a targeted level of detail, subsurface conditions, surface conditions, or other like factors. The specified spacing may be tens of meters, for example. The placement of the one or more sensors may involve multiple workers performing an assembly line of activities. For instance, a first worker may mark each location of a plurality of locations, a second worker may dig a hole at each location of the plurality of locations, and yet a third worker may place a sensor in each hole and then fill in the hole.

However, workers may misplace a sensor introducing a human error that may reduce an accuracy or resolution of the seismic data collected. Additionally, remote locations or harsh environments including one or more of rough terrain, extreme temperatures, dense vegetation, or other like hazardous conditions may be challenging to access, unsafe for workers to survey, or a combination thereof.

According to embodiments of the present disclosure, a self-burrowing seismic-sensing tool is described and includes a navigator, implemented by a processor, configured to determine a course to a target destination within a subsurface formation, where the course is based on a current location received from one or more sensors. The self-burrowing seismic-sensing tool also includes a burrower, implemented by the processor, configured to operate (direct) a burrowing device to the target destination based on the course and a data acquisition unit, implemented by the processor, configured to generate seismic data based on seismic waves received at the target destination. Self-burrowing, as used herein, indicates that the seismic-sensing tool is semi-autonomous, untethered, and able to burrow itself into the earth's surface. The self-burrowing seismic-sensing tool may also include a command unit, implemented by the processor, configured to receive one or more commands or operational errors and to determine one or more operation modes based upon the one or more commands or operational errors. In response to one or more of the operation modes, the burrower may cause the burrowing device to ascend or descend within the ground, the data acquisition unit may acquire or cease acquiring data, or a transceiver may transmit a signal.

Using the self-burrowing seismic-sensing tool, as described herein, enables seismic surveys without relying on workers in the land survey area. Removing workers from the process of placing the one or more sensors reduces a likelihood of human error that reduces the accuracy or resolution of the seismic data collected. The workers are also protected from unsafe survey conditions. Additionally, the self-burrowing seismic-sensing tool can be used in other industries outside of oil and gas, for example, in the mining industry, the quarry industry, the hydrological industry, the liquid waste disposal industry, the geothermal energy industry, the agriculture industry, the geologic greenhouse gas storage industry, or like industries in which drilling or quarrying of subterranean formations can be performed or submersing underground sensors is required.

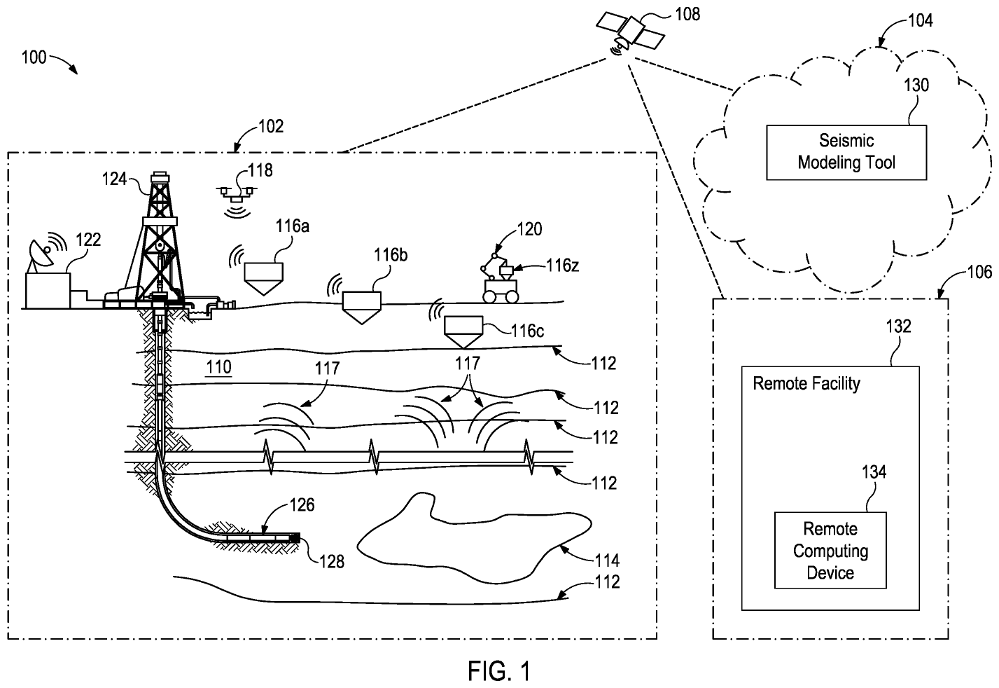

FIG. 1 is a schematic diagram of an example system 100 for acquiring seismic data using a self-burrowing seismic-sensing tool, shown as tools 116a, 116b, 116c, 116z, in accordance with certain embodiments. Self-burrowing seismic-sensing tools 116a, 116b, 116c, 116z may herein be referred to collectively as the self-burrowing seismic-sensing tools 116. The self-burrowing seismic-sensing tools 116 receive seismic waves 117 and generate seismic data in response to receipt of the seismic waves 117.

In certain embodiments, the self-burrowing seismic-sensing tools 116 may be delivered and/or retrieved by one or more aerial delivery tools 118 or land delivery tools 120 to and/or from a survey area 102. Aerial delivery tool 118 may be a drone, a remotely operated airplane, an autonomous aerial vehicle, or other like unmanned aerial vehicle. Land delivery tool 120 may be a remotely operated land vehicle, an autonomous ground vehicle, or other like unmanned ground vehicles. The unmanned ground vehicle may be wheeled or legged, for example. One or more of the aerial delivery tool 118 or the land delivery tool 120 may include one or more robotic arms, clamps, or other like systems for delivering or retrieving the self-burrowing seismic-sensing tools 116. The survey area 102 may be a remote location or harsh environment. In a non-limiting example, the survey area 102 may be a field having a subsurface formation 110 present below the surface of the earth and being explored or developed for hydrocarbons. The field may include a rig 124 communicatively coupled to a control site 122, for example.

Each self-burrowing seismic-sensing tool 116 is delivered to a surface location of the subsurface formation 110. In a non-limiting example, the self-burrowing seismic-sensing tools 116 are delivered to different surface locations based on a global positioning system (GPS), geographic coordinate system, or other like mapping system. In another non-limiting example, the self-burrowing seismic-sensing tools 116 are delivered at different distances relevant to a specified reference site. The specified reference site may be determined by an operator of the system 100, a seismic survey plan, or the like. The specified reference site may be associated with a grid system, for example. Grid system, as used herein, is a mapping system providing reference coordinates for multiple self-burrowing seismic-sensing tools, for example. The grid system may be a two-dimensional or three-dimensional system. For example, in addition to coordinates along an x-axis and a y-axis, z-axis coordinates could be used to specify an elevation or a depth. The specified reference site may be the rig 124 or the control site 122, for example. In a non-limiting example, self-burrowing seismic-sensing tool 116a may be located at a first distance from the rig 124, self-burrowing seismic-sensing tool 116b may be located at a second distance that is further from the rig 124 than the self-burrowing seismic-sensing tool 116a, self-burrowing seismic-sensing tool 116c may be located at a third distance that is further from the rig 124 than the self-burrowing seismic-sensing tools 116a and 116b, and self-burrowing seismic-sensing tool 116z may be located at a fourth (or zth) distance that is further from the rig 124 than the self-burrowing seismic-sensing tools 116a, 116b, and 116c.

In certain embodiments, the self-burrowing seismic-sensing tools 116 may each be delivered along a substantially linear path. Substantially, as used herein, indicates that each of the self-burrowing seismic-sensing tools 116 are within a specified threshold distance of the linear path. The specified threshold distance may be determined by an operator of the system 100, may be included in a seismic survey plan associated with subsurface formation 110, or the like. The specified threshold distance may be dependent upon geologic surface features that impede placement of one or more of the self-burrowing seismic-sensing tools 116 in a position that is disposed along the linear path, for example.

In various embodiments, to generate seismic waves 117, one or more sources (e.g., seismic vibrators, explosions, acoustic sources) (not explicitly shown) are activated at different control points (e.g., one or more surface locations specified in a seismic survey plan, by an operator of the system 100, or the like) along a surface of the subsurface formation 110. The sources may be activated at different surface locations of the subsurface formation 110. The sources generate seismic waves 117 that propagate in the subsurface formation 110, and are reflected back toward the surface when a boundary between two sedimentary layers 112 having different properties is encountered. The reflected seismic waves 117 are received by the self-burrowing seismic-sensing tools 116. The self-burrowing seismic-sensing tools 116 may generate seismic data based on the seismic waves 117.

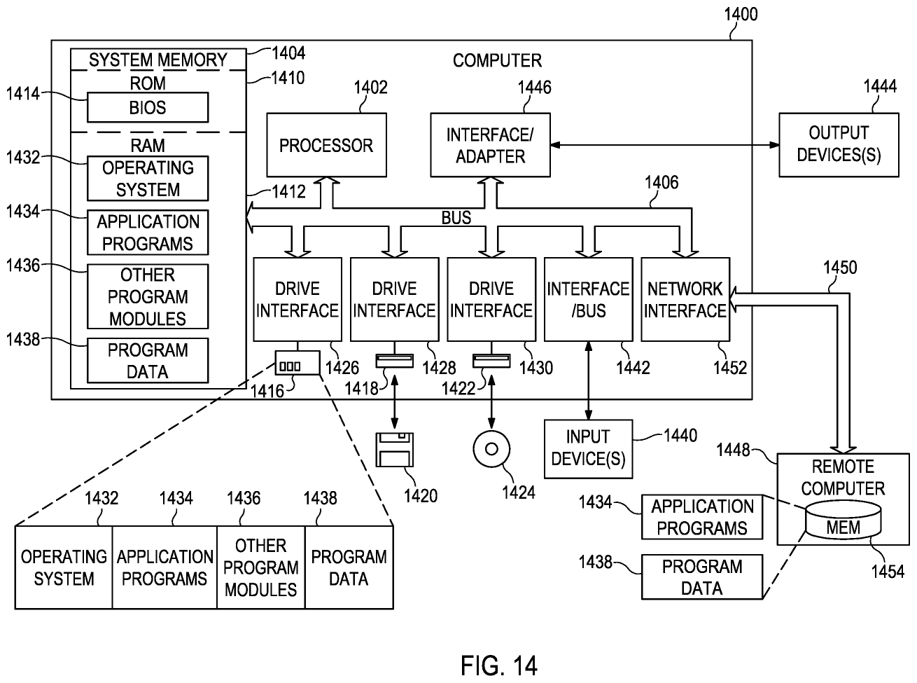

The seismic data may be stored to a computer-readable medium. The computer-readable medium may be a computer-readable medium as described with respect to FIG. 14, for example. The computer-readable medium may be local to the self-burrowing seismic-sensing tools 116 or remote to the self-burrowing seismic-sensing tools 116. For example, the computer-readable medium may be a computer-readable medium of the self-burrowing seismic-sensing tools 116, a cloud provider 104, or a computing device 134 at a facility 132 of a remote location 106. In a non-limiting example, the self-burrowing seismic-sensing tools 116, the cloud provider 104, or the remote computing device 134 are communicatively coupled via a wired connection (e.g., cable) or a wireless connection (e.g., Wi-Fi, Bluetooth). One or more communication relays 108 (e.g., satellite, antenna, modem, router, network hub, or the like) may facilitate the communication connections.

In various embodiments, the cloud provider 104 provides resources, such as infrastructure-as-a-service (IaaS) (e.g., computing resources such as processing and storage, security), software-as-a-service (SaaS) (e.g., web-based tools), or the like via the internet. In a non-limiting example, the cloud provider 104 may host a seismic modeling tool 130. The seismic modeling tool 130 may be communicatively coupled to the computer-readable medium storing seismic data generated by the self-burrowing seismic-sensing tools 116. The seismic modeling tool 130 may use the seismic data to generate or update a formation model of the subsurface formation 110, for example. The formation model may include the different sedimentary layers 112 as well as a geological feature 114, for example. In a non-limiting example, the formation model may be used to steer a drill bit 128 operatively coupled to a bottom-hole assembly (BHA) 126.

While the seismic modeling tool 130 is shown as hosted by the cloud provider 104, in other examples, the seismic modeling tool 130 may be located on the remote computing device 134. Deploying the self-burrowing seismic-sensing tools 116 in the field being explored or developed for hydrocarbons using the rig 124 enables high fidelity modeling of the subsurface formation 110. High fidelity modeling of the subsurface formation 110 may mitigate the risk of collapse of the rig 124 created by drilling into unstable formations.

In some embodiments, each self-burrowing seismic-sensing tool 116 may be equipped with a wireless communication unit capable of underground communication (e.g., Wi-Fi, Bluetooth, etc.) with other wireless communication units. In at least one embodiment, the communication relay 108 may help facilitate the wireless communication between each self-burrowing seismic-sensing tool 116. In such embodiments, the self-burrowing seismic-sensing tools 116 may create a network of underground sensors, where each sensor collects a seismic wave and subsequently transmits the seismic data to a nearby self-burrowing seismic-sensing tools 116 to transmit or “hop” the data. The data continues to be transmitted or “hopped” to nearby self-burrowing seismic-sensing tools 116 until it reaches the self-burrowing seismic-sensing tool 116 closest to the control site 122 at the surface. As will be appreciated, this may help achieve real-time seismic data acquisition. Moreover, this embodiment may be applicable to establishing an underground network of sensors and a corresponding underground internet of things (UIoT).

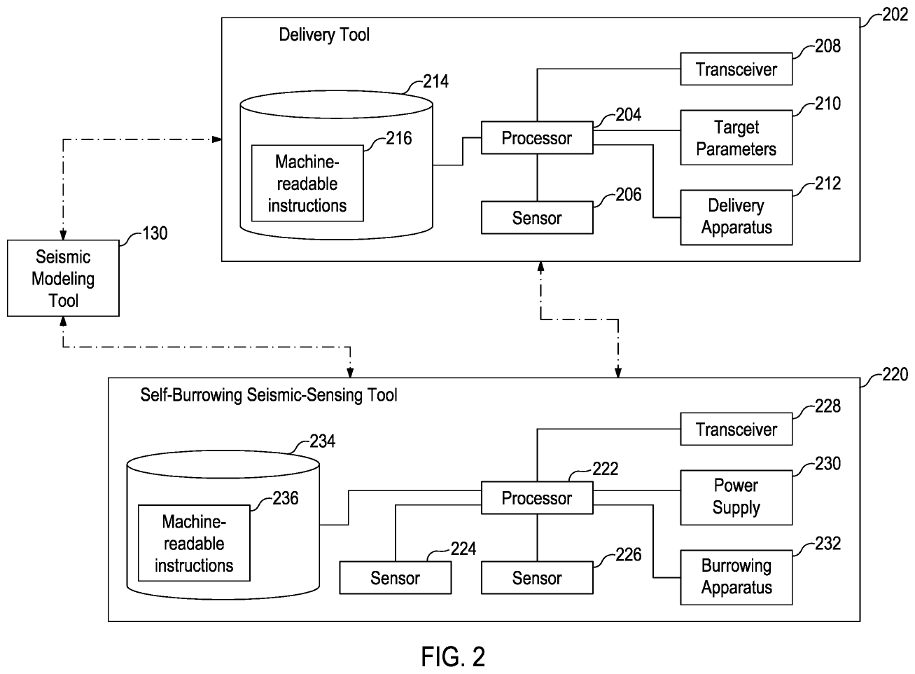

FIG. 2 is a block diagram of an example system 200 for acquiring seismic data using a self-burrowing seismic-sensing tool 220, in accordance with certain embodiments. The system 200 may be the system 100, for example. The delivery tool 202 may deliver the self-burrowing seismic-sensing tool 220 to a survey area. The delivery tool 202 may be the aerial delivery tool 118 or the land delivery tool 120 described with respect to FIG. 1, for example. The self-burrowing seismic-sensing tool 220 may generate seismic data based on seismic waves received during seismic surveying of a subsurface formation. The self-burrowing seismic-sensing tool 220 may be the self-burrowing seismic-sensing tool 116a, 116b, 116c, 116z described with respect to FIG. 1, for example. The seismic modeling tool 130 may receive the seismic data to generate a formation model for the subsurface formation.

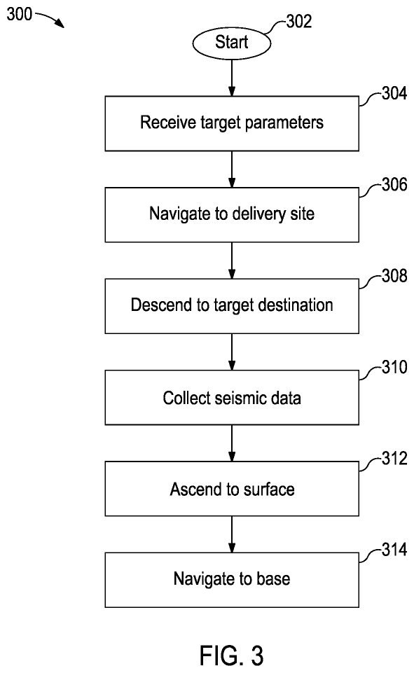

In certain embodiments, the delivery tool 202 includes a processor 204 coupled to a sensor 206, a transceiver 208, a power supply 210, a delivery apparatus 212, and a computer-readable medium 214 storing machine-readable instructions 216. The processor 204 may be a processor described with respect to FIG. 14, for example. The sensor 206 may include one or more of an electromagnetic sensor, a global positioning sensor (GPS), a radar sensor, a LIDAR sensor, an image sensor, a gravity sensor (e.g., an accelerometer), a proximity sensor, an altitude sensor, a pressure sensor, or other like sensors for determining a location of and detecting hazards to the delivery tool 202. The power supply 210 may be one or more of a generator, a battery, photovoltaic cells, or other like sources of energy for powering the delivery tool 202. The delivery apparatus 212 may be one or more robotic arms, one or more clamps, or other like electromechanical devices for carrying, releasing, and/or retrieving objects. The computer-readable medium 214 may be a computer-readable medium as described with respect to FIG. 14, for example. In a non-limiting example, the machine-readable instructions 216, when executed by the processor 204, cause the processor to operate the delivery tool 202 as described with respect to FIG. 3.

In certain embodiments, the self-burrowing seismic-sensing tool 220 includes a processor 222 coupled to a first sensor 224, a second sensor 226, a transceiver 228, a power supply 230, a burrowing apparatus 232, and a computer-readable medium 234 storing machine-readable instructions 236. The processor 222 may be a processor described with respect to FIG. 14, for example. The first sensor 224 may be an electromagnetic sensor, a global positioning sensor (GPS), a radar sensor, a LIDAR sensor, a gravity sensor (e.g., an accelerometer), a proximity sensor, an image sensor, an altitude sensor, a pressure sensor, or other like sensor for determining a location of and detecting hazards to the self-burrowing seismic-sensing tool 220. The second sensor 226 may be a geophone, a hydrophone, a seismic detector, or other like sensors for measuring seismic energy or vibrations. The power supply 230 may be one or more of a generator, a battery, photovoltaic cells, or other like sources of energy for powering the self-burrowing seismic-sensing tool 220. The burrowing apparatus 232 may be one or more robotic arms, one or more drills, or other like electromechanical devices configured to and otherwise capable of advancing into the subsurface formation 110 (FIG. 1) or “burrowing” into the subsurface formation 110. The computer-readable medium 234 may be a computer-readable medium as described with respect to FIG. 14, for example. In a non-limiting example, the machine-readable instructions 216, when executed by the processor 204, cause the processor to operate the delivery tool 202 as described with respect to FIG. 3. In a non-limiting example, the self-burrowing seismic-sensing tool 220 may also include one or more components of the delivery tool 202 to enable the self-burrowing seismic-sensing tool 220 to deliver and/or retrieve itself or other self-burrowing seismic-sensing tools to a survey area.

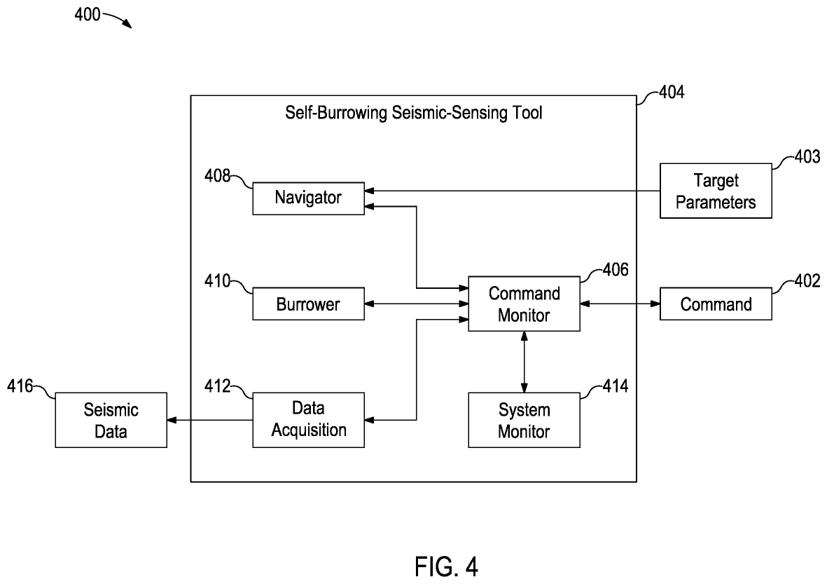

FIG. 3 is a flow diagram of an example method 300 for acquiring seismic data using a self-burrowing seismic-sensing tool, in accordance with certain embodiments. The self-burrowing seismic-sensing tool may be the self-burrowing seismic-sensing tool 116a, 116b, 116c, 116z described herein with respect to FIG. 1, or the self-burrowing seismic-sensing tool 220 described herein with respect to FIG. 2, for example. In certain embodiments, method 300 is used by system 100 of FIG. 1, system 200 of FIG. 2, or system 400 of FIG. 4. Method 300 includes starting (block 302), receiving target parameters (block 304), navigating to a delivery site (block 306), descending to a target destination (block 308), collecting seismic data (block 310), ascending to the surface (block 312), and navigating to a base (block 314).

Starting block 302 includes, but is not limited to, receiving an input from a user, the present system, another system, or a combination thereof, which indicates the present system is to perform the method 300. The user may use a computer system, such as the remote computing device 134 of FIG. 1, to input data or a command, for example. In a non-limiting example, the input may be a command to execute a computer application (e.g., the seismic modeling tool 130 of FIG. 1). A computer application, as used herein, may include any type of application, program, or automated process having computer-executable instructions, which, when executed by a processor (not explicitly shown), enable access to specified operations or data. The user may use a graphical user interface (GUI) of the computer application to indicate the present system is to perform the method 300, for example. The computer application may include an application programming interface (API) server, a web server, or other like interface component (not explicitly shown) that enables communication between the computer application and the self-burrowing seismic-sensing tool for example. In another non-limiting example, the input may be a command from another tool. The other tool may be another self-burrowing seismic-sensing tool or a delivery tool, for example. The delivery tool may be the aerial delivery tool 118 of FIG. 1, the land delivery tool 120 of FIG. 1, or the delivery tool 202 of FIG. 2, for example.

Receiving the target parameters at block 304 includes, but is not limited to, receiving the target parameters from one or more computer-readable medium, input devices, network interfaces (e.g., receiving the target parameters via a transceiver or communication relay), or a combination thereof, associated with the present system, another system, or a combination thereof. The target parameters may include one or more delivery sites, one or more target destinations, one or more target depths, a specified reference site, one or more elevations, one or more distances, or a combination thereof. Alternatively, or in addition thereto, the target parameters may be based on magnetic sensors (e.g., Hall effect sensors) included in the robot and operable to sense a magnetic field generated at the surface, which allows the robot to navigate itself to the source for accurate retrieval. Delivery site, as used herein, is a surface location to which a self-burrowing seismic-sensing tool is to be delivered. Target destination, as used herein, is a subsurface location to which the self-burrowing seismic-sensing tool is to burrow (advance underground) to acquire seismic data. The target destination may be based on GPS coordinates, a geographic coordinate system, or other like mapping system. The target depth, as used herein, is a depth to which the self-burrowing seismic-sensing tool is to burrow to acquire seismic data. The target depth may be relative to an elevation of a delivery site, for example. In another non-limiting example, the target depth may be a depth of the subsurface formation through which the self-burrowing seismic-sensing tool is to burrow. For example, target parameters for a delivery tool (e.g., the aerial delivery tool 118 of FIG. 1, the land delivery tool 120 of FIG. 1, the delivery tool 202 of FIG. 2) may include one or more of a specified reference site, multiple distances, or multiple delivery sites to which to deliver multiple self-burrowing seismic-sensing tools (e.g., self-burrowing seismic-sensing tools 116 of FIG. 1, self-burrowing seismic-sensing tool 220 of FIG. 2). In another example, target parameters for the self-burrowing seismic-sensing tool may also include a specified depth to which the self-burrowing seismic-sensing tool is to burrow from one or more of a delivery site or a reference elevation.

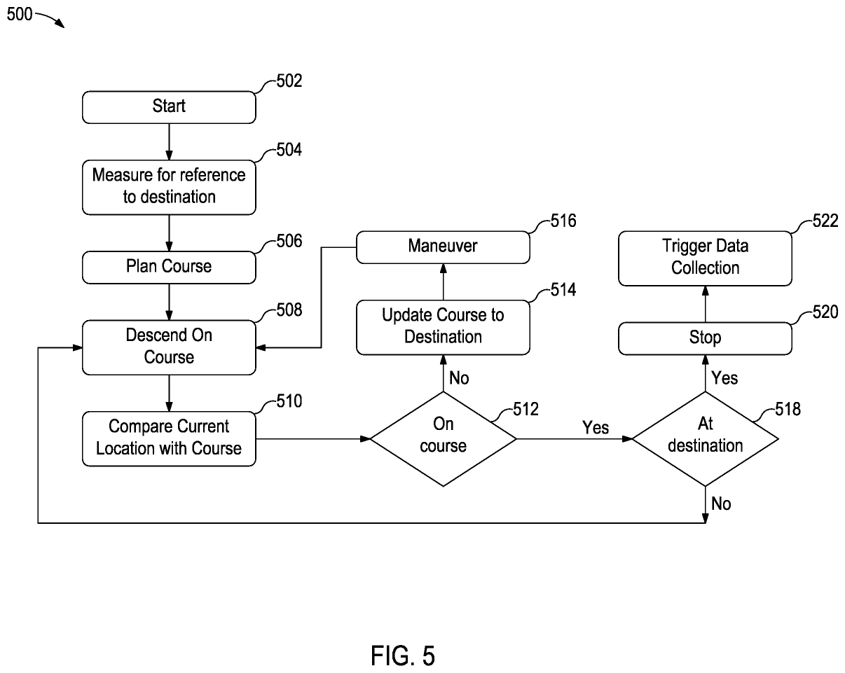

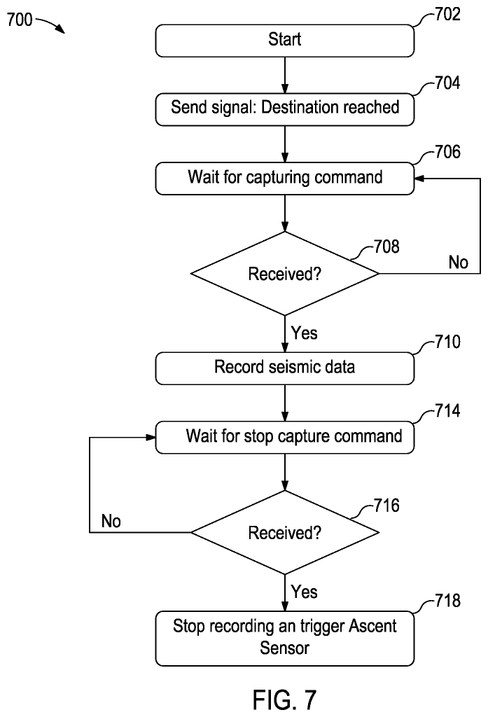

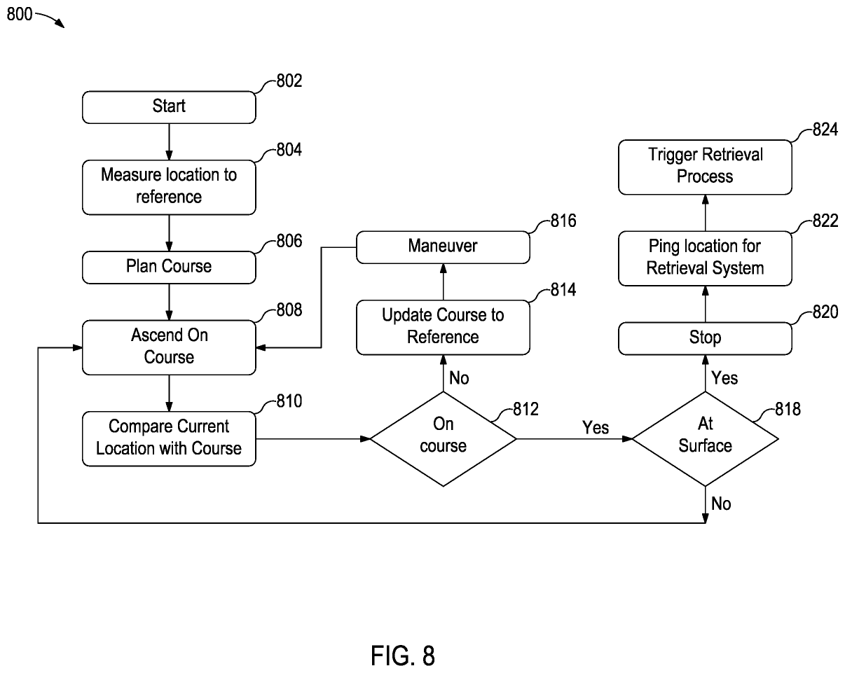

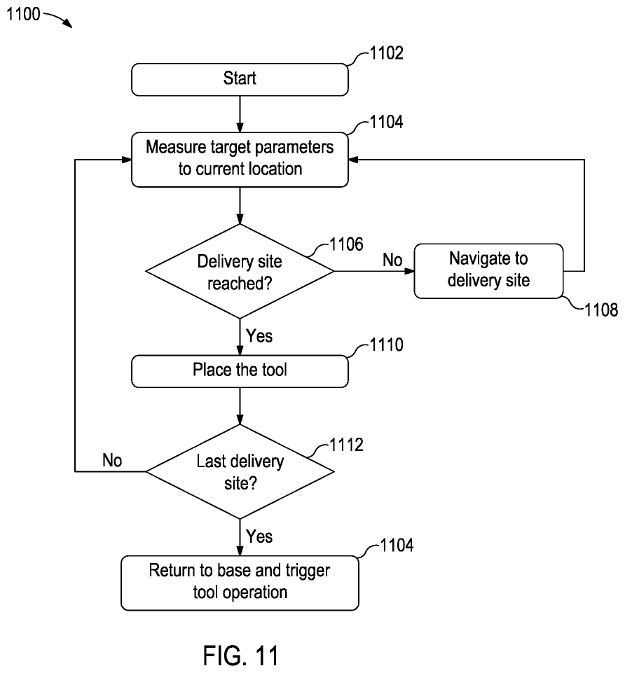

Navigating to delivery site at block 306 may include performing one or more steps of the method 1100, as described below with reference to FIG. 11. Descending to the target at block 308 may include performing one or more steps of the method 500 described below with reference to FIG. 5. Collecting seismic data at block 310 may include performing one or more steps of the method 700 described below with reference to FIG. 7. Ascending to the surface at block 312 may include performing one or more steps of the method 800 described below with reference to FIG. 8. Navigating to base at block 314 may include performing one or more steps of the method 1100 described herein with reference to FIG. 11.

FIG. 4 is a block diagram of a self-burrowing seismic-sensing tool 404, in accordance with certain embodiments. The self-burrowing seismic-sensing tool 404 may be the self-burrowing seismic-sensing tool 116a, 116b, 116c, 116z described with respect to FIG. 1 or the self-burrowing seismic-sensing tool 220 described with respect to FIG. 2, for example. The self-burrowing seismic-sensing tool 404 is configured to receive one or more of commands 402, target parameters 403, seismic waves (e.g., seismic waves 117 of FIG. 1), or a combination thereof, and to generate seismic data 416 based on the seismic waves.

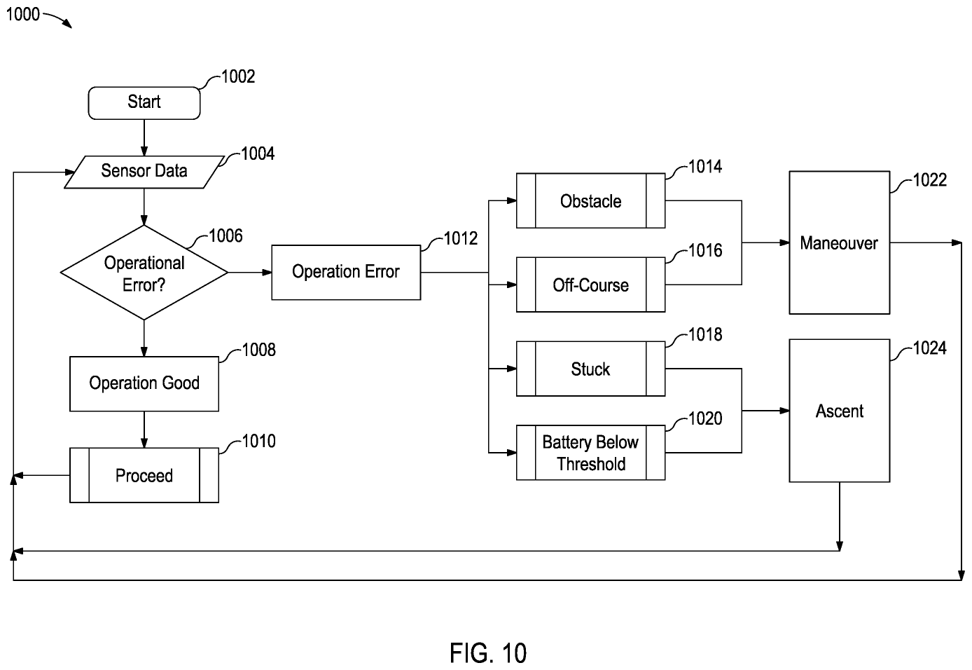

In certain embodiments, self-burrowing seismic-sensing tool 404 includes a navigator 408, implemented by a processor (e.g., the processor 222 of FIG. 2), and configured to determine a course to a target destination within a subsurface formation (e.g., subsurface formation 110 of FIG. 1) based on a current location received from one or more sensors (e.g., first sensor 224 of FIG. 2, second sensor 226 of FIG. 2), a burrower 410, implemented by the processor, and configured to operate a burrowing device (e.g., burrowing apparatus 232 of FIG. 2) to the target destination based on the course, and a data acquisition unit 412, implemented by the processor, and configured to generate seismic data 416 based on seismic waves received at the target destination. The current location may include one or more coordinates based on a mapping system, an elevation, a depth, or a combination thereof. Self-burrowing seismic-sensing tool 404 may also include a command monitor 406, implemented by the processor, configured to receive one or more commands 402 or operational errors and to determine one or more operation modes based upon the one or more commands 402 or operational errors. Command monitor 406 may determine the one or more operation modes by performing one or more steps of the method 1000 described with reference to FIG. 10, for example.

In a non-limiting example, the one or more operation modes may indicate one or more of descent, ascent, course planning, data acquisition, delivery, retrieval, hopping a communication signal, or an operational error, for example. Operational errors may include navigational errors (e.g., obstacle encountered, proximity to obstacle, off course, or the like) and system errors. Self-burrowing seismic-sensing tool may also include system monitor 414, implemented by the processor, and configured to monitor for one or more system errors. The one or more system errors may indicate that one or more components of the self-burrowing seismic-sensing tool 404 are functioning outside normal parameters. The one or more system errors may indicate that a battery charge is below a specified threshold, that a sensor output indicates a sensor is non-operable, or that a burrowing apparatus is non-operable, for example.

In various embodiments, the navigator 408 determines the course by performing one or more steps of the method 500 described with respect to FIG. 5 or the method 800 described with respect to FIG. 8. In some embodiments, the burrower 410 causes the burrowing device to descend in response to the one or more operation modes indicating to descend, or to ascend in response to the one or more operation modes indicating to ascend. The burrower 410 may cause the burrowing device to descend to the target by performing one or more steps of the method 500 described with respect to FIG. 5, for example. The burrower 410 may cause the burrowing device to ascend to the surface by performing one or more steps of the method 800 described with respect to FIG. 8, for example. In other embodiments, the data acquisition unit 412 acquires data in response to the one or more operation modes indicating to begin seismic data acquisition and ceases acquiring data in response to the one or more operation modes indicating to cease seismic data acquisition. The data acquisition unit 412 may generate seismic data 416 by performing one or more steps of the method 700 described with respect to FIG. 7, for example. In various embodiments, the command monitor 406 causes a transceiver (e.g., transceiver 228 of FIG. 2) to transmit a signal in response to the one or more operation modes indicating that the self-burrowing seismic-sensing tool 404 is waiting for retrieval.

In certain embodiments, the navigator 408 may receive target parameters 403. The navigator 408 may receive target parameters 403 from one or more of computer-readable medium, input devices, network interfaces (e.g., receiving the target parameters via a transceiver or communication relay from a computer application of a remote system (e.g., seismic modeling tool 130 of FIG. 1, remote computing device 134 of FIG. 1)), for example. In a non-limiting example, the navigator 408 may navigate to a delivery site associated with the target destination. The navigator 408 may perform one or more steps of the method 1100 described with respect to FIG. 11 to navigate to the delivery site, for example. In other embodiments, command monitor 406 may receive target parameters 403 in conjunction with, or subsequent to, command 402. Command 402 may be a signal received via a transceiver (e.g., transceiver 228 of FIG. 2). The signal may include a command indicating that the self-burrowing seismic-sensing tool 404 is to receive target parameters 403, for example. In other examples, the command 402 may be a signal that indicates to plan a course, descend, travel to a delivery site, travel to a base, act as a communication relay, or output seismic data 416. In a non-limiting example, in response to receiving command 402 to output seismic data 416, command monitor 406 may cause data acquisition unit 412 to output seismic data 416.

In various embodiments, the command monitor 406 may receive additional commands from one or more of navigator 408, burrower 410, or system monitor 414. For example, navigator 408 may generate a command indicating that a course has been planned. The course may be a course for descending or ascending (e.g., through the ground below the earth's surface), and in a non-limiting example, navigator 408 may generate a different command based on the type of course planned. In another non-limiting example, navigator 408 may generate a command based on sensor input (e.g., the first sensor 224 of FIG. 2). Navigator 408 may determine the self-burrowing seismic-sensing tool 404 is off course based on the sensor input, and may generate a command (or signal) indicating that the self-burrowing seismic-sensing tool 404 is off course, for example. In other non-limiting examples, the burrower 410 may generate a command based on sensor input that that the target destination has been reached, an obstacle has been encountered, or a surface location has been reached, and the burrower 410 may generate a command indicating the event associated with the sensor input. In a non-limiting example, system monitor 414 may generate different commands in response to different operational errors.

FIG. 5 is a flow diagram of an example method 500 for acquiring seismic data (e.g., seismic data 416 of FIG. 4) using a self-burrowing seismic-sensing tool (e.g., self-burrowing seismic-sensing tools 116 of FIG. 1, self-burrowing seismic-sensing tool 220 of FIG. 2, self-burrowing seismic-sensing tool 404 of FIG. 4) in accordance with certain embodiments. One or more components of the self-burrowing seismic-sensing tool may perform one or more steps of method 500, for example. In certain embodiments, method 500 is used by system 100 of FIG. 1, system 200 of FIG. 2, or system 400 of FIG. 4. Method 500 includes starting (block 502), measuring for a reference to a target destination (block 504), planning a course (block 506), descending on course (block 508), comparing a current location to the course (block 510), determining whether the self-burrowing seismic-sensing tool is on course (block 512), updating course to the target destination (block 514), maneuvering (block 516), determining whether the target destination has been reached (block 518), ceasing descent (block 520) and triggering data collection (block 522).

Starting block 502 includes, but is not limited to, receiving an input from a user, the present system, another system, or a combination thereof, which indicates the present system is to perform the method 500. In a non-limiting example, the input may be target parameters (e.g., target parameters 403 of FIG. 4). In another non-limiting example, the input may be a command from another tool. The other tool may be another self-burrowing seismic-sensing tool or a delivery tool, for example, such as the aerial delivery tool 118 of FIG. 1, the land delivery tool 120 of FIG. 1, or the delivery tool 202 of FIG. 2. The command may include one or more of a command to start operations or to receive the target parameters.

Measuring for a reference to a target destination at block 504 may include determining one or measurements. The method 500 may include determining a measurement between a current location of the self-burrowing seismic-sensing tool and the target destination. The current location may be a surface location associated with a delivery site of the self-burrowing seismic-sensing tool, for example. Method 500 may include determining the current location using a sensor. The current location may be determined by navigator 408 of FIG. 4 using an input from the first sensor 224 of FIG. 2, for example. In some embodiments, method 500 includes determining one or more of a distance from the current location to the target destination or a difference in elevation between the current location and the target destination. The method 500 may include storing to a computer-readable medium the current location, the distance, or the difference in elevation as the reference.

Planning the course at block 506 may include determining one or more steps for the self-burrowing seismic-sensing tool to perform to navigate from the current location to the target destination. In a non-limiting example, the course is a direct, or path of least distance, to burrow from the current location to the target destination. In certain embodiments, method 500 may include using one or more sensors to determine a layout of a surrounding surface area. Method 500 may include determining a surface route around an obstacle to navigate the self-burrowing seismic tool to a second surface location that is different than the delivery site. The second surface location may decrease a burrowing distance from the surface to the target destination, for example. Method 500 may also include determining a route around partially buried or fully buried obstacles. Locations of the buried obstacles may be stored to a computer-readable medium of the self-burrowing seismic-sensing tool, for example. The route around the partially buried or fully buried obstacles may include one or more of a surface route or a burrowing route. In a non-limiting example, the course may include one or more of directions, distances, coordinates, elevations, depths, or like parameters to aid in navigation. In some examples, the criteria (e.g., obstacle, action to take) for determining the course may be determined by an operator of the system, a seismic survey plan, or the like. The criteria (e.g., obstacle, action to take) for planning the course may be stored to a computer-readable medium of the self-burrowing tool or the delivery tool, for example.

Descending on the course at block 508 may include actuating a burrowing device. In a non-limiting example, the burrower 410 of FIG. 4 may actuate the burrowing apparatus 232 of FIG. 2. The burrowing device may burrow through the subsurface formation based upon the course determined at block 506, for example.

In various embodiments, method 500 includes determining a current location of the self-burrowing seismic-sensing tool at periodic intervals. The periodic interval may be specified by an operator of the system, a seismic survey plan, or the like. The periodic interval may be stored to a computer-readable medium of the self-burrowing tool or the delivery tool, for example. Method 500 includes comparing the current location to the course at block 510. In a non-limiting example, method 500 includes generating an indicator in response to the comparison. For example, method 500 may include generating a first indicator in response to the comparison indicating that the current location deviates from the course by a specified threshold and a second indicator in response to the comparison indicating the current location does not deviate from the course by more than the specified threshold. The specified threshold may be specified by an operator of the system, a seismic survey plan, or the like. The specified threshold may be stored to a computer-readable medium of the self-burrowing tool or the delivery tool, for example.

In some embodiments, method 500 includes determining whether the self-burrowing seismic-sensing tool is on course at block 512 based on a result of the comparison. For example, in response to the first indicator, method 500 may include determining that the self-burrowing seismic-sensing tool is off course and in response to the second indicator, method 500 may include determining that the self-burrowing seismic-sensing tool is on course. In various embodiments, in response to a determination that the self-burrowing seismic-sensing tool is off course, method 500 includes updating the course to the target destination, as at bock 514. In a non-limiting example, method 500 may include determining one or measurements between a current location of the self-burrowing seismic-sensing tool and the target destination. Method 500 may also include determining one or more steps for the self-burrowing seismic-sensing tool to perform to navigate from the current location to the target destination. Method 500 may include performing one or more maneuvers at block 516 to re-position the self-burrowing seismic-sensing tool for descent according to the updated course at block 508. In a non-limiting example, the one or more maneuvers may be stored to a computer-readable medium of the self-burrowing seismic-sensing tool. The one or more maneuvers may include actuating different components of the self-burrowing seismic-sensing tool, such as a drill bit, a vibration generator, one or more actuators, or any combination thereof.

In other embodiments, in response to a determination that the self-burrowing seismic-sensing tool is on course, method 500 includes determining whether the target destination has been reached at block 518. Method 500 includes comparing the current location to the target destination to determine whether the target destination has been reached, for example. In a non-limiting example, method 500 includes generating an indicator in response to the comparison. For example, method 500 may include generating a first indicator in response to the comparison indicating that the current location deviates from the target destination by less than a specified threshold and a second indicator in response to the comparison indicating the current location does not deviate from the target destination by less than the specified threshold. The specified threshold may be specified by an operator of the system, a seismic survey plan, or the like. The specified threshold may be stored to a computer-readable medium of the self-burrowing tool or the delivery tool, for example.

In some embodiments, method 500 includes determining whether the self-burrowing seismic-sensing tool has reached the target destination at block 518 based on a result of the comparison. For example, in response to the first indicator, method 500 may include determining that the self-burrowing seismic-sensing tool is at the target destination, and in response to the second indicator, method 500 may include determining that the self-burrowing seismic-sensing tool has not reached the target destination. In various embodiments, in response to a determination that the self-burrowing seismic-sensing tool is not at the target destination, method 500 includes continuing descent according to the current course at block 508. In response to a determination that the self-burrowing seismic-sensing tool is at the target destination, method 500 may include ceasing descent of the burrowing device.

In various embodiments, triggering data collection at block 522 may include generating one or more commands. Method 500 may include updating an operation mode to trigger a data acquisition unit, for example. The data acquisition unit may be the data acquisition unit 412 of FIG. 4, for example. In a non-limiting example, triggering the data acquisition unit may supply power to the data acquisition unit. In another non-limiting example, method 500 may include sending a command to the data acquisition unit to begin recording seismic data in response to receipt of seismic waves. Method 500 may also include storing the seismic data to a computer-readable medium of the self-burrowing seismic-sensing tool.

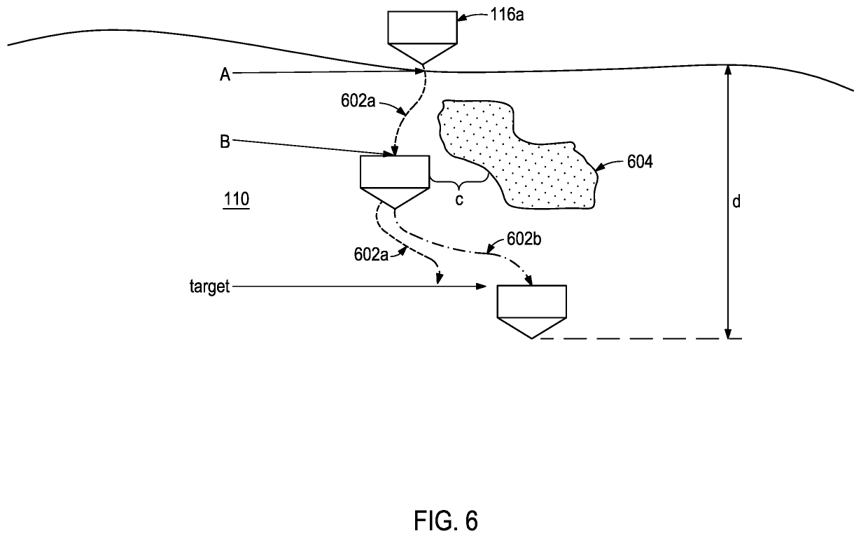

FIG. 6 is a schematic diagram of an example self-burrowing seismic-sensing tool 116a navigating the subsurface formation 110, in accordance with certain embodiments. Upon arrival at a delivery site, self-burrowing seismic-sensing tool 116a may receive a signal. The signal may include one or more of a command to start burrowing operations or target parameters. Self-burrowing seismic-sensing tool 116a may perform one or more measurements in response to receiving the signal. Self-burrowing seismic-sensing tool 116a may determine a current location “A”, for example. Self-burrowing seismic-sensing tool 116a may also determine a distance (“d”) from the current location to the target destination (“target”). The distance may be a depth to which the self-burrowing seismic-sensing tool is to burrow (i.e., advance into the subsurface formation 110) or a difference in elevation between the current location and the target destination, for example. Self-burrowing seismic-sensing tool 116a may plan course 602a to navigate from “A” to the “target” using the measurements. Self-burrowing seismic-sensing tool 116a may plan course 602a to route around obstacle 604, for example.

In certain embodiments, after determining course 602a, self-burrowing seismic-sensing tool 116a may actuate a burrowing apparatus included on or forming part of the self-burrowing seismic-sensing tool 116a. Self-burrowing seismic-sensing tool 116a may burrow through the subsurface formation 110 based upon course 602a. Self-burrowing seismic-sensing tool 116a may receive one or more sensor inputs while traversing course 602a. In a non-limiting example, in response to a determination that a distance “c” between obstacle 604 and current location “B” of the self-burrowing seismic-sensing tool 116a is outside a specified threshold, self-burrowing seismic-sensing tool 116a may determine second course 602b from current location “B” to “target.” The specified threshold may be specified by an operator of the system, a seismic survey plan, or the like. The specified threshold may be stored to a computer-readable medium of the self-burrowing tool 116a, for example. Self-burrowing seismic-sensing tool 116a may continue to burrow through the subsurface formation 110 based upon course 602b. Upon reaching “target,” self-burrowing seismic-sensing tool 116a may cease descent (i.e., movement downwards through the subsurface formation 110).

FIG. 7 is a flow diagram of an example method 700 for acquiring seismic data (e.g., seismic data 416 of FIG. 4) using a self-burrowing seismic-sensing tool (e.g., self-burrowing seismic-sensing tools 116 of FIG. 1, self-burrowing seismic-sensing tool 220 of FIG. 2, self-burrowing seismic-sensing tool 404 of FIG. 4) in accordance with certain embodiments. One or more components of the self-burrowing seismic-sensing tool may perform one or more steps of method 700, for example. In certain embodiments, method 700 is used by system 100 of FIG. 1, system 200 of FIG. 2, or system 400 of FIG. 4. Method 700 includes starting (block 702), sending a signal that target destination has been reached (block 704), waiting for capturing command (block 706), determining whether the capturing command has been received (block 708), recording seismic data (block 710), waiting for stop capture command (block 714), determining whether the stop capture command has been received (block 716), stopping recording and triggering ascent sensor (block 718).

Starting block 702 includes, but is not limited to, receiving an input from another component of the self-burrowing seismic-sensing tool which indicates to perform method 700. In a non-limiting example, the input may be a command including an operation mode that triggers a data acquisition unit. In certain embodiments, the method 700 may include transmitting a signal, via a transceiver (e.g., transceiver 228) in response to the operation mode that triggers the data acquisition unit. The signal may indicate that the target destination has been reached, for example. Method 700 may include waiting for receipt of a signal, via the transceiver, where the signal includes a command (e.g., command 402 of FIG. 4). In response to receiving a signal, via the transceiver, method 700 determines whether the capturing command has been received at block 708. The capturing command may indicate that the data acquisition unit is to begin one or more of receiving seismic waves, generating seismic data based on the seismic waves, or recording seismic data.

In response to a determination that the capturing command has been received, method 700 may include sending a command to the data acquisition unit to begin recording seismic data, for example. In another example, in response to the determination that the capturing command has been received, method 700 may include modifying an operation mode to indicate that the data acquisition unit is to begin recording seismic data. Recording seismic data at block 710 may include storing the seismic data to one or more of a memory of the data acquisition unit or another computer-readable medium of the self-burrowing seismic-sensing tool. Method 700 may include waiting for receipt of a signal, via the transceiver, that indicates for the data acquisition unit to stop recording seismic data. In response to receiving a signal, via the transceiver, method 700 determines whether the stop capture command has been received at block 716. In response to a determination that the stop capture command has been received, method 700 may include modifying the operation mode to indicate to cease collection of the seismic data, to trigger ascent from the target destination to the surface location, as at block 718, or a combination thereof.

Method 700 may include updating an operation mode to stop the data acquisition unit recording, for example. In a non-limiting example, triggering the ascent sensor may supply power to one or more of a sensor used for ascending or the burrowing device.

FIG. 8 is a flow diagram of an example method 800 for acquiring seismic data (e.g., seismic data 416 of FIG. 4) using a self-burrowing seismic-sensing tool (e.g., self-burrowing seismic-sensing tools 116 of FIG. 1, self-burrowing seismic-sensing tool 220 of FIG. 2, self-burrowing seismic-sensing tool 404 of FIG. 4) in accordance with certain embodiments. One or more components of the self-burrowing seismic-sensing tool may perform one or more steps of method 800, for example. In certain embodiments, method 800 is used by system 100 of FIG. 1, system 200 of FIG. 2, or system 400 of FIG. 4. Method 800 includes starting (block 802), measuring from a current location to a reference (block 804), planning a course (block 806), ascending on course (block 808), comparing a current location to the course (block 810), determining whether the self-burrowing seismic-sensing tool is on course (block 812), updating course to the reference (block 814), maneuvering (block 816), determining whether the surface has been reached (block 818), ceasing ascent (block 820), pinging location for a retrieval system (block 822), and triggering a retrieval process (block 824).

Starting block 802 includes, but is not limited to, receiving an input from another component of the self-burrowing seismic-sensing tool which indicates to perform method 800. In a non-limiting example, the input may be a command. The command may include an operation mode that triggers a sensor (e.g., first sensor 224 of FIG. 2), the burrowing device, or a combination thereof. Triggering the sensor, the burrowing device, or the combination thereof may cause power to be supplied to one or more of a sensor used for ascending or the burrowing device, for example.

Measuring from the current location to the reference at block 804 may include determining one or measurements between the current location (e.g., the target destination) of the self-burrowing seismic-sensing tool and the reference. Method 800 may include retrieving the reference from a computer-readable medium of the self-burrowing seismic-sensing tool. The current location may be determined using the techniques described with respect to FIG. 5, for example. In some embodiments, method 800 includes determining one or more of a distance from the current location to the reference or a difference in elevation between the current location and the reference.

Planning the course at block 806 may include determining one or more steps for the self-burrowing seismic-sensing tool to perform to navigate from the current location to the reference. In a non-limiting example, the course is a direct, or path of least distance, to ascend from the current location to the reference. In certain embodiments, method 800 may include using one or more sensors to determine a layout of a surrounding surface area. Method 800 may also include determining a route around partially buried or fully buried obstacles. Locations of the buried obstacles may be stored to a computer-readable medium of the self-burrowing seismic-sensing tool, for example. In a non-limiting example, the course may include one or more of directions, distances, coordinates, elevations, depths, or like parameters to aid in navigation. In some examples, the criteria (e.g., obstacle, action to take) for determining the course may be determined by an operator of the system, a seismic survey plan, or the like. The criteria (e.g., obstacle, action to take) for planning the course may be stored to a computer-readable medium of the self-burrowing tool or the delivery tool, for example.

In some embodiments, ascending on the course at block 808 may include actuating a burrowing device. In various embodiments, method 800 includes determining a current location of the self-burrowing seismic-sensing tool at periodic intervals. Method 800 may determine the current location using techniques described in FIG. 5, for example. Method 800 includes comparing the current location to the course at block 810. In a non-limiting example, method 800 includes generating an indicator in response to the comparison. For example, method 800 may generate indicators using techniques described in FIG. 5.

In some embodiments, method 800 includes determining whether the self-burrowing seismic-sensing tool is on course at block 812 based on a result of the comparison. Method 800 may include determining whether the self-burrowing seismic-sensing tool is on course using techniques described in FIG. 5, for example. In various embodiments, in response to a determination that the self-burrowing seismic-sensing tool is off course, method 800 includes updating the course to the reference. In a non-limiting example, method 800 may include determining one or measurements between a current location of the self-burrowing seismic-sensing tool and the reference. Method 800 may also include determining one or more steps for the self-burrowing seismic-sensing tool to perform to navigate from the current location to the reference. Method 800 may include performing one or more maneuvers at block 816 to re-position the self-burrowing seismic-sensing tool for ascent according to the updated course at block 808.

In other embodiments, in response to a determination that the self-burrowing seismic-sensing tool is on course, method 800 includes determining whether the reference has been reached at block 818. Method 800 includes comparing the current location to the reference to determine whether the surface has been reached, for example. In another non-limiting example, method 800 includes determining the surface has been reached using a sensor. For example, method 800 may include capturing an image of a surrounding area with an image sensor to determine whether the surface has been reached.

In various embodiments, in response to a determination that the self-burrowing seismic-sensing tool is not at the surface, method 800 includes continuing ascent according to the current course at block 808. In response to a determination that the self-burrowing seismic-sensing tool is at the surface, method 800 may include ceasing ascent of the burrowing device. Pinging location for the retrieval system at block 822 includes transmitting a signal, via a transceiver, that includes the location. The retrieval system may be another tool. The other tool may be another self-burrowing seismic-sensing tool or a delivery tool, for example. The delivery tool may be the aerial delivery tool 118 of FIG. 1, the land delivery tool 120 of FIG. 1, or the delivery tool 202 of FIG. 2, for example.

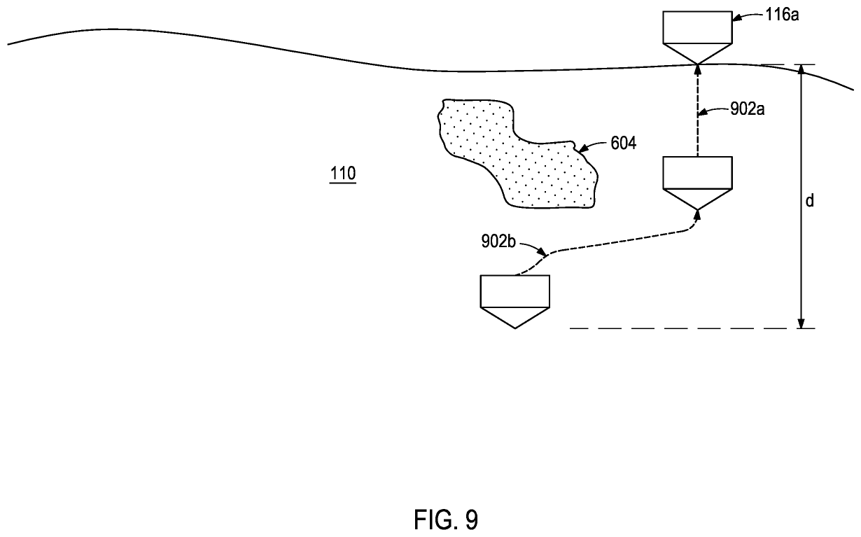

FIG. 9 is a diagram of the self-burrowing seismic-sensing tool 116a navigating the subsurface formation 110, in accordance with certain embodiments. Upon receiving a command indicating that an operation mode indicates to ascend, self-burrowing seismic-sensing tool 116a may perform one or more measurements. In a non-limiting example, self-burrowing seismic-sensing tool 116a may determine a current location, for example. Self-burrowing seismic-sensing tool 116a may also determine a distance (“d”) from the current location to the surface. The distance may be a depth through which the self-burrowing seismic-sensing tool is to burrow or a difference in elevation between the current location and the surface, for example. Self-burrowing seismic-sensing tool 116a may plan course 902 to navigate from the current location to the surface using the measurements. In a non-limiting example, self-burrowing seismic-sensing tool 116a may plan course 902 to include a first course 902a to route around obstacle 604 and a second course 902b to ascend to the surface using a direct path.

FIG. 10 is a flow diagram of an example method 1000 for acquiring seismic data (e.g., seismic data 416 of FIG. 4) using a self-burrowing seismic-sensing tool (e.g., self-burrowing seismic-sensing tools 116 of FIG. 1, self-burrowing seismic-sensing tool 220 of FIG. 2, self-burrowing seismic-sensing tool 404 of FIG. 4), in accordance with certain embodiments. One or more components of the self-burrowing seismic-sensing tool may perform one or more steps of method 1000, for example. In certain embodiments, method 1000 is used by system 100 of FIG. 1, system 200 of FIG. 2, or system 400 of FIG. 4. Method 1000 includes starting (block 1002), receiving sensor data (block 1004), determining whether there is an operational error (block 1006), determining that operations are good (block 1008), proceeding with operations (block 1010), determining there is an operational error (block 1012), determining the operational error indicates an obstacle (block 1014), determining the operational error indicates the tool is off course (block 1016), determining the operational error indicates the tool is stuck (block 1018), determining the operational error indicates a battery charge is below a threshold (block 1020), maneuvering (block 1022), and ascending (block 1024).

Starting block 1002 includes, but is not limited to, receiving an input. In a non-limiting example, the input may be received from another tool, such as another self-burrowing seismic-sensing tool or a delivery tool (e.g., aerial delivery tool 118 of FIG. 1, land delivery tool 120 of FIG. 1, delivery tool 202 of FIG. 2). The input may be one or more of target parameters (e.g., target parameters 403 of FIG. 4) or a command (e.g., command 402 of FIG. 4) for the self-burrowing seismic-sensing tool to begin operations, for example. The command may cause a command monitor (e.g., command monitor 406 of FIG. 4) to determine an operation mode that triggers other components of the self-burrowing seismic-sensing tool, for example. The other components may include a sensor (e.g., first sensor 224 of FIG. 2, second sensor 226 of FIG. 2), a burrowing device (e.g., burrowing apparatus 232 of FIG. 2), a power supply (e.g., power supply 230 of FIG. 2), a navigator (e.g., navigator 408 of FIG. 4), a burrower (e.g., burrower 410), a data acquisition unit (e.g., data acquisition unit 412 of FIG. 4), a system monitor (e.g., system monitor 414 of FIG. 4), or a combination thereof. Triggering a component enables operations of the component by causing power to be supplied or sending one or more signals that cause the component to be placed in an operational state, for example.

In a non-limiting example, receiving sensor data at block 1004 includes receiving data from one or more sensors of the self-burrowing seismic-sensing tool. The sensor data may be received by one or more of the command monitor or a system monitor (e.g., system monitor 414 of FIG. 4), for example. Method 1000 may include comparing the sensor data to one or more operational parameters. The operational parameters may include one or more ranges, thresholds, or tolerances that indicate whether the sensor data is indicative of operations in accordance with specifications (e.g., “normal operations”). The specifications may be supplied by a manufacturer of a component, an operator of the present system, a seismic survey planner, or a combination thereof. The operational parameters may be stored to a computer-readable medium of the self-burrowing seismic-sensing tool, for example. In response to a determination that the comparison indicates that the sensor data is indicative of normal operations, method 1000 includes waiting for receipt of more sensor data.

In response to a determination that the comparison indicates that the sensor data is not indicative of normal operations, method 1000 includes determining an operational error associated with one or more of the sensor data indicating operations not in accordance with specifications. In a non-limiting example, in response to a determination that the operational error indicates that an obstacle has been contacted or proximity to the obstacle has been detected or that the self-burrowing seismic-sensing tool is off course, method 1000 includes determining one or more maneuvers to perform. The one or more maneuvers may be performed using techniques described with respect to FIG. 5, for example. Different maneuvers may be performed based on the operational error. For example, a first set of maneuvers may be performed in response to contact with an obstacle, a second set of maneuvers may be performed in response to proximity detection with the obstacle, and a third set of maneuvers may be performed in response to the self-burrowing seismic-sensing tool being off course. In another non-limiting example, in response to a determination that the operational error indicates that the self-burrowing seismic-sensing tool is stuck or that a battery is not operating normally, method 1000 includes planning a course for ascending. The course may be planned using techniques described with respect to FIG. 8, for example.

FIG. 11 is a flow diagram of an example method 1100 for delivering a self-burrowing seismic-sensing tool (e.g., self-burrowing seismic-sensing tools 116 of FIG. 1, self-burrowing seismic-sensing tool 220 of FIG. 2, self-burrowing seismic-sensing tool 404 of FIG. 4) in accordance with certain embodiments. In certain embodiments, method 1100 is used by system 100 of FIG. 1, system 200 of FIG. 2, or system 400 of FIG. 4. Method 1100 may be performed by a delivery tool (e.g., aerial delivery tool 118 of FIG. 1, the land delivery tool 120 of FIG. 1, or the delivery tool 202 of FIG. 2) or a self-burrowing seismic-sensing tool capable of delivering itself and/or other self-burrowing seismic-sensing tools to a survey area, for example. Method 1100 includes starting (block 1102), measuring target parameters to current location (block 1104), determining whether the delivery site has been reached (block 1106), navigating to the delivery site (block 1108), delivering a self-burrowing seismic-sensing tool (block 1110), determining whether the last delivery site has been reached (block 1112), and returning to base and triggering tool operation (block 1114).

Starting block 1102 includes, but is not limited to, receiving an input from a user, the present system, another system, or a combination thereof, which indicates the present system is to perform method 1100. The user may use a computer system (e.g., remote computing device 134 of FIG. 1) to input data or a command, for example. The data may be one or more of a seismic survey plan, one or more target parameters (e.g., target parameters 403 of FIG. 4), or a combination thereof, for example. In a non-limiting example, the command may be to trigger operations of a delivery tool or the self-burrowing seismic-survey tool. In some embodiments, the input may be received from another tool. The other tool may be another self-burrowing seismic-sensing tool or another delivery tool, for example.

In some embodiments, method 1100 includes determining a current location. The current location may be received from one or more sensors (e.g., sensor 206 of FIG. 2, first sensor 224 of FIG. 2, second sensor 226 of FIG. 2), for example. In another non-limiting example, the current location may be a location of a base or a retrieval site received as an input. Method 1100 also includes comparing the current location to one or more delivery sites specified by target parameters. Method 1100 includes determining a delivery site of the one or more delivery sites that is closest to, but not inclusive of, the current location. Method 1100 also includes planning a course from the current location to the delivery site of the one or more delivery sites that is closest to, but not inclusive of, the current location. Method 1100 includes navigating to the delivery site of the one or more delivery sites that is closest to, but not inclusive of, the current location based on the course.

In certain embodiments, method 1100 includes sampling the current location at periodic intervals to determine whether the delivery site has been reached. In response to a determination that the delivery site has not been reached at block 1106, method 1100 includes navigating to the delivery site at block 1108. In response to a determination that the delivery site has been reached at block 1106, method 1100 includes placing a self-burrowing seismic-sensing tool associated with the delivery site at block 1110.

In various embodiments, method 1100 includes determining whether to place the self-burrowing seismic-sensing tool at a surface location that is different than the delivery site. For example, method 1100 may include using a sensor to determine a layout of a surrounding surface area of the delivery site. Method 1100 may include determining whether the surrounding surface area indicates a first surface type (e.g., sand dunes) or a second surface type (e.g., hard rock). In response to a determination that the surrounding surface area is a first surface type, method 1100 may include placing an additional self-burrowing seismic-sensing tool having a different delivery site at the current delivery site. In response to a determination that the surrounding surface area is a second surface type, method 1100 may include placing the self-burrowing seismic-sensing tool at a second surface location that is different than the delivery site. In a non-limiting example, the criteria (e.g., surface type, action to take) for determining the placement may be determined by an operator of the system, a seismic survey plan, or the like. The criteria (e.g., surface type, action to take) for determining the placement may be stored to a computer-readable medium of the self-burrowing tool or the delivery tool, for example.

In certain embodiments, method 1100 includes determining a number of delivery sites specified by target parameters. In a non-limiting example, determining whether the last delivery site has been reached at 1106 includes determining whether self-burrowing seismic-sensing tools have been placed at the number of delivery sites. Method 1100 may include incrementing or decrementing a counter with each delivery, for example. In response to a determination that more deliveries are to be made, method 1100 also includes comparing the current location to one or more remaining delivery sites specified by target parameters. Method 1100 includes determining a delivery site of the one or more remaining delivery sites that is closest to, but not inclusive of, the current location. Method 1100 also includes planning a course from the current location to the delivery site of the one or more remaining delivery sites that is closest to, but not inclusive of, the current location. Method 1100 includes navigating to the delivery site of the one or more remaining delivery sites that is closest to, but not inclusive of, the current location based on the course.

In various embodiments, in response to a determination that the last delivery site has been reached at 1106, method 1100 includes planning a course from the current location to a base. The base may be a remote facility (e.g., the remote facility 132 of FIG. 1) or a control site (e.g., the control site 122 of FIG. 1), for example.

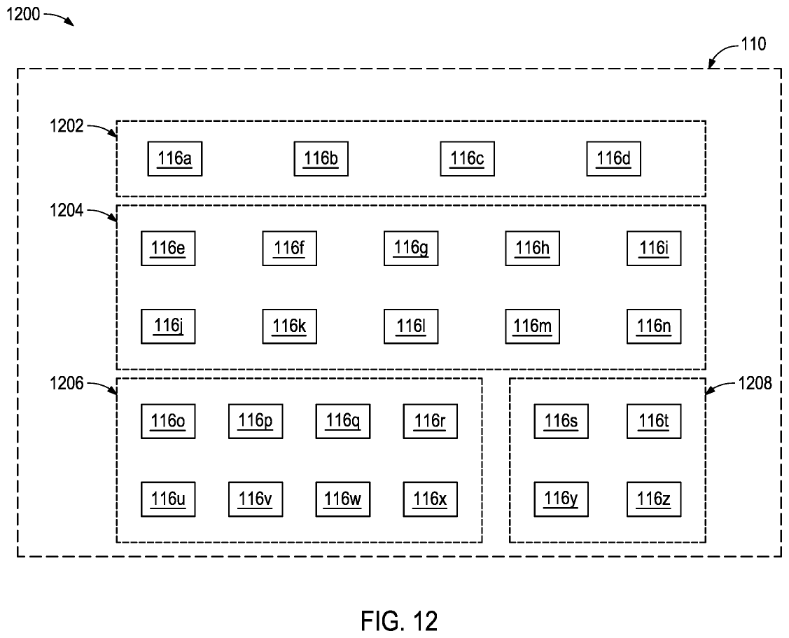

FIG. 12 is a block diagram aerial view of a plurality of self-burrowing seismic-sensing tools 116 located within the subsurface formation 110, in accordance with certain embodiments. Self-burrowing seismic-sensing tools 116a-116z are herein collectively referred to as the plurality of self-burrowing seismic-sensing tools 116. A layout 1200 of the plurality of self-burrowing seismic-sensing tools may be determined by one or more of a seismic survey plan, surface terrain of the subsurface formation 110, or a combination thereof. To implement layout 1200, the plurality of self-burrowing seismic-sensing tools 116 may be delivered to a surface of the subsurface formation 110 using techniques described herein.

In certain embodiments, each of the self-burrowing seismic-sensing tools 116 may be delivered along a substantially linear path. Substantially, as used herein, indicates that each of the self-burrowing seismic-sensing tools 116 are within a specified threshold distance of the linear path. The specified threshold distance may be determined by an operator of the system (e.g., system 100 of FIG. 1, system 200 of FIG. 2, system 400 of FIG. 4), may be included in a seismic survey plan associated with subsurface formation 110, input by a user (e.g., a user of the seismic modeling tool 130 of FIG. 1) or the like. The specified threshold distance may be dependent upon geologic surface features that impede placement of one or more of the self-burrowing seismic-sensing tools 116 in a position that is exactly disposed along the linear path, for example.

In various embodiments, a delivery tool may modify one or more delivery sites associated with a first set 1202 of the plurality of self-burrowing seismic-sensing tools 116 based on a surface type of the one or more delivery sites. For example, a first delivery tool may modify the one or more delivery sites associated with the first set 1202 of the plurality of self-burrowing seismic-sensing tools 116 after determining that the surface of the subsurface formation 110 is hard rock. A second delivery tool may deliver a second set 1204 of the plurality of self-burrowing seismic-sensing tools 116 along a substantially linear path in accordance with a layout of the seismic survey plan. A third delivery tool may modify one or more delivery sites associated with a third set 1206 of the plurality of self-burrowing seismic-sensing tools 116 on a surface type of the one or more delivery sites. For example, the third delivery tool may modify the one or more delivery sites associated with the third set 1206 of the plurality of self-burrowing seismic-sensing tools 116 after determining that the surface of the subsurface formation 110 is sand. The third delivery tool may modify the delivery site of multiple self-burrowing seismic-sensing tools of the third set 1206 and deliver the third set 1206 to a single delivery site, for example. The first delivery tool may deliver a fourth set 1208 of the plurality of self-burrowing seismic-sensing tools 116 along a substantially linear path in accordance with a layout of the seismic survey plan.

In certain embodiments, in response to delivery tool completing delivery of the plurality of self-burrowing seismic-sensing tools 116, the delivery tool transmits a signal to trigger each of the plurality of self-burrowing seismic-sensing tools 116 to burrow to a respective target destination. In some examples, in response to receiving a signal from each of the plurality of self-burrowing seismic-sensing tools 116 indicating that the respective target destination has been reached, the delivery tool transmits a signal to begin capturing seismic data. In other examples, in response to receiving a signal from each of the plurality of self-burrowing seismic-sensing tools 116 indicating that the respective target destination has been reached, the delivery tool transmits a signal to a remote computer system (e.g., control site 122 of FIG. 1, remote computing device 134 of FIG. 1) indicating that the plurality of self-burrowing seismic-sensing tools 116 are each at a respective target destination. The delivery tool may relay a signal from the remote computer system indicating to begin capturing seismic data to the plurality of self-burrowing seismic-sensing tools 116.

In other embodiments, the plurality of self-burrowing seismic-sensing tools 116 transmit signals to each other while burrowing to respective target destinations. Each self-burrowing seismic-sensing tool of the plurality of self-burrowing seismic-sensing tools 116 may determine a distance to nearest tool neighbors based on the signals. One or more of the plurality of self-burrowing seismic-sensing tools 116 may plan a modified course in response to a determination that the distance to a nearest neighbor is less than a threshold distance. The threshold distance may be specified in a seismic survey plan, for example. By communicating with each other within the subsurface formation, the plurality of self-burrowing seismic-sensing tools 116 are able to coordinate to ensure optimal placement for seismic data acquisition. Additionally, the plurality of self-burrowing seismic-sensing tools 116 are able to synchronize communications to indicate the plurality of self-burrowing seismic-sensing tools 116 are at respective target destinations once a last self-burrowing seismic-sensing tool of the plurality of self-burrowing seismic-sensing tools 116 has reached its respective target destination.

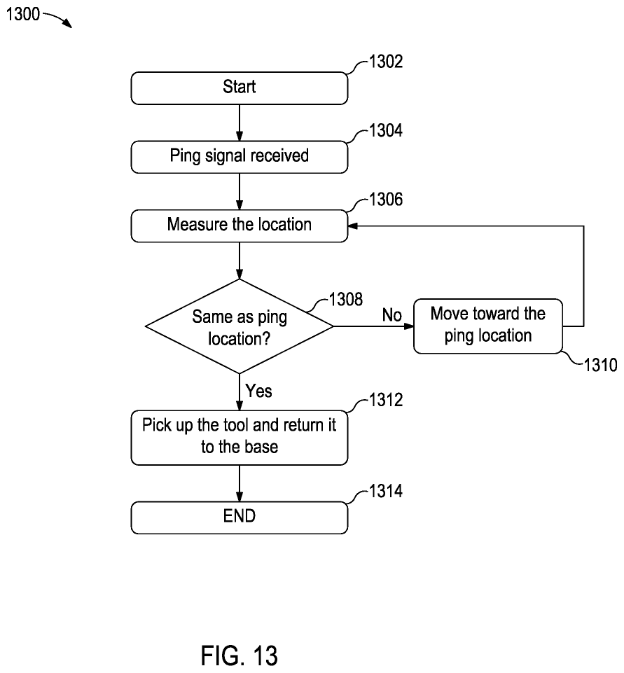

FIG. 13 is a flow diagram of an example method 1300 for retrieving a self-burrowing seismic-sensing tool (e.g., self-burrowing seismic-sensing tools 116 of FIG. 1, self-burrowing seismic-sensing tool 220 of FIG. 2, self-burrowing seismic-sensing tool 404 of FIG. 4) in accordance with certain embodiments. In certain embodiments, method 1300 is used by system 100 of FIG. 1, system 200 of FIG. 2, or system 400 of FIG. 4. Method 1300 may be performed by a delivery tool (e.g., aerial delivery tool 118 of FIG. 1, the land delivery tool 120 of FIG. 1, or the delivery tool 202 of FIG. 2) or a self-burrowing seismic-sensing tool capable of retrieving itself and/or other self-burrowing seismic-sensing tools from a survey area, for example. The tool performing the method 1300 may be referred to as a retrieval tool. Method 1300 includes starting (block 1302), receiving a ping signal (block 1304), measuring a current location (block 1306), determining whether the current location is a same location as the ping location (block 1308), traveling to the ping location (block 1310), picking up a tool and returning to base (block 1312), and ending (block 1314).

Starting block 1302 includes, but is not limited to, receiving an input from a user, the present system, another system, or a combination thereof, which indicates the present system is to perform method 1300. The user may use a computer system (e.g., remote computing device 134 of FIG. 1) to input data or a command, for example. In a non-limiting example, the command may be to trigger operations of the retrieval tool. In some embodiments, the input may be received from another tool. The other tool may be another self-burrowing seismic-sensing tool or another delivery tool, for example.

In some embodiments, in response to receiving the ping signal at block 1304, method 1300 includes causing the retrieval tool to exit a standby mode. In a non-limiting example, the ping signal includes a location of the self-burrowing seismic-sensing tool transmitting the ping signal. In another non-limiting example, method 1300 includes determining a location from which the ping signal originated using techniques such as measuring signal strength, pinging the self-burrowing seismic-sensing tool and measuring a response time, or other like methods. Method 1300 also includes determining a current location of the retrieval tool. The current location may be received from one or more sensors (e.g., sensor 206 of FIG. 2, first sensor 224 of FIG. 2, second sensor 226 of FIG. 2), for example. In another non-limiting example, the current location may be a location of a base or a retrieval site received as an input.

In certain embodiments, method 1300 includes comparing the current location to the ping location. Method 1300 includes determining whether the current location is a same location as the ping location based on the comparison. In response to a determination that the current location is not the ping location, method 1300 also includes planning a course from the current location to the ping location. Method 1300 includes navigating to the ping location based on the course.

In various embodiments, method 1300 includes sampling the current location at periodic intervals to determine whether the ping location has been reached. In response to a determination that the ping location has not been reached at block 1308, method 1300 includes navigating to the ping location at block 1310. In response to a determination that the ping location has been reached at block 1308, method 1300 includes retrieving one or more self-burrowing seismic-sensing tools at the ping location at block 1312.

In some embodiments, in response to receiving multiple ping signals, method 1300 includes determining a ping location of the one or more ping signals that is closest to, but not inclusive of, the current location. Method 1300 also includes planning a course from the current location to the ping location of the one or more ping signals that is closest to, but not inclusive of, the current location. Method 1300 includes navigating to the ping location of the one or more ping signals that is closest to, but not inclusive of, the current location based on the course.

In certain embodiments, method 1300 includes determining whether a last retrieval site has been reached. The determination may be based on whether additional ping signals are received, whether a time threshold for receipt of a ping signal has elapsed, or other like method, for example. In response to a determination that the last retrieval site has been reached, method 1300 includes planning a course from the current location to a base. The base may be a remote facility (e.g., the remote facility 132 of FIG. 1) or a control site (e.g., the control site 122 of FIG. 1), for example.

The steps of methods 300, 500, 700, 800, 1000, 1100, 1300 may be executed by one or multiple self-burrowing seismic-sensing tools described herein. The steps of methods 300, 500, 700, 800, 1000, 1100, 1300 may be executed in any order and in any combination not logically prohibited and may individually be executed one or more times. Using the self-burrowing seismic-sensing tools described herein protects workers from hazardous conditions as well as prevents potential injuries from encountering natural elements. Additionally, the self-burrowing seismic-sensing tools reduce costs of a seismic survey by reducing a number of workers needed to deploy seismic-sensing tools and increasing a speed at which the seismic survey may be conducted.

In view of the foregoing structural and functional description, those skilled in the art will appreciate that portions of the embodiments may be embodied as a method, data processing system, or computer program product. Accordingly, these portions of the present embodiments may take the form of an entirely hardware embodiment, an entirely software embodiment, or an embodiment combining software and hardware, such as shown and described with respect to the computer system of FIG. 14. Furthermore, portions of the embodiments may be a computer program product on a computer-readable medium having computer-readable program code on the medium. Any non-transitory, tangible storage media possessing structure may be utilized including, but not limited to, static and dynamic storage devices, hard disks, optical storage devices, and magnetic storage devices, but excludes any medium that is not eligible for patent protection under 45 U.S.C. § 101 (such as a propagating electrical or electromagnetic signal per se). As an example and not by way of limitation, a computer-readable storage media may include a semiconductor-based circuit or device or other integrated component (IC) (such as, for example, a field-programmable gate array (FPGA) or an ASIC), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. A computer-readable non-transitory storage medium may be volatile, nonvolatile, or a combination of volatile and non-volatile, where appropriate.

Certain embodiments have also been described herein with reference to block illustrations of methods, systems, and computer program products. It will be understood that blocks of the illustrations, and combinations of blocks in the illustrations, can be implemented by computer-executable instructions. These computer-executable instructions may be provided to one or more processor of a general purpose computer, special purpose computer, or other programmable data processing apparatus (or a combination of devices and circuits) to produce a machine, such that the instructions, which execute via the processor, implement the functions specified in the block or blocks.

These computer-executable instructions may also be stored in computer-readable memory that can direct a computer or other programmable data processing apparatus to function in a particular manner, such that the instructions stored in the computer-readable memory result in an article of manufacture including instructions which implement the function specified in the flowchart block or blocks. The computer program instructions may also be loaded onto a computer or other programmable data processing apparatus to cause a series of operational blocks to be performed on the computer or other programmable apparatus to produce a computer implemented process such that the instructions which execute on the computer or other programmable apparatus provide blocks for implementing the functions specified in the flowchart block or blocks.

FIG. 14 is a block diagram of a computer system that can be employed to execute a system for analyzing ransomware threat intelligence in accordance with certain embodiments described. Computer system 1400 can be implemented on one or more general purpose networked computer systems, embedded computer systems, routers, switches, server devices, client devices, various intermediate devices/nodes or standalone computer systems. Additionally, computer system 1400 can be implemented on various mobile clients such as, for example, a personal digital assistant (PDA), laptop computer, pager, and the like, provided it includes sufficient processing capabilities.

Computer system 1400 includes processing unit 1402, system memory 1404, and system bus 1406 that couples various system components, including the system memory 1404, to processing unit 1402. Dual microprocessors and other multi-processor architectures also can be used as processing unit 1402. System bus 1406 may be any of several types of bus structure including a memory bus or memory controller, a peripheral bus, and a local bus using any of a variety of bus architectures. System memory 1404 includes read only memory (ROM) 1410 and random access memory (RAM) 1412. A basic input/output system (BIOS) 1414 can reside in ROM 1410 containing the basic routines that help to transfer information among elements within computer system 1400. In other examples, a unified extended firmware interface (UEFI) includes the basic routines that help transfer information among elements within computer system 1400.

Computer system 1400 can include a hard disk drive 1416, magnetic disk drive 1418, e.g., to read from or write to removable disk 1420, and an optical disk drive 1422, e.g., for reading CD-ROM disk 1424 or to read from or write to other optical media. Hard disk drive 1416, magnetic disk drive 1418, and optical disk drive 1422 are connected to system bus 1406 by a hard disk drive interface 1426, a magnetic disk drive interface 1428, and an optical drive interface 1440, respectively. The drives and associated computer-readable media provide nonvolatile storage of data, data structures, and computer-executable instructions for computer system 1400. Although the description of computer-readable media above refers to a hard disk, a removable magnetic disk and a CD, other types of media that are readable by a computer, such as magnetic cassettes, flash memory cards, digital video disks and the like, in a variety of forms, may also be used in the operating environment; further, any such media may contain computer-executable instructions for implementing one or more parts of embodiments shown and described herein.

A number of program modules may be stored in drives and RAM 1412, including operating system 1432, one or more computer application programs 1434, other program modules 1436, and program data 1438. In some examples, the computer application programs 1434 can include the seismic modeling tool 130 of FIG. 1, the delivery tool 202 of FIG. 2, or the self-burrowing seismic-sensing tool 220 of FIG. 2, and the program data 438 can include seismic data 416 of FIG. 4. The computer application programs 1434 and program data 1438 can include functions and methods programmed to perform the computer-implemented methods 300, 500, 700, 800, 1000, 1100, 1300 for a self-burrowing seismic-sensing tool, such as shown and described herein.

A user may enter commands and information into computer system 1400 through one or more input devices 1440, such as a pointing device (e.g., a mouse, touch screen), keyboard, microphone, joystick, game pad, scanner, and the like. For instance, the user can employ input device 1440 to edit or modify settings, such as a target destination, of the seismic modeling tool 130 of FIG. 1, the delivery tool 202 of FIG. 2, or the self-burrowing seismic-sensing tool 220 of FIG. 2. These and other input devices 1440 are often connected to processing unit 1402 through a corresponding port interface 1442 that is coupled to the system bus, but may be connected by other interfaces, such as a parallel port, serial port, or universal serial bus (USB). One or more output devices 1444 (e.g., display, a monitor, printer, projector, or other type of displaying device) is also connected to system bus 1406 via interface 1446, such as a video adapter.

Computer system 1400 may operate in a networked environment using logical connections to one or more remote computers, such as remote computer 1448. Remote computer 1448 may be a workstation, computer system, router, peer device, or other common network node, and typically includes many or all the elements described relative to computer system 1400. The logical connections, schematically indicated at 1450, can include a local area network (LAN) and a wide area network (WAN). When used in a LAN networking environment, computer system 1400 can be connected to the local network through a network interface or adapter 1452. When used in a WAN networking environment, computer system 1400 can include a modem, or can be connected to a communications server on the LAN. The modem, which may be internal or external, can be connected to system bus 1406 via an appropriate port interface. In a networked environment, computer application programs 1434 or program data 1438 depicted relative to computer system 1400, or portions thereof, may be stored in a remote memory storage device 1454.

Embodiments disclosed herein include:

A. A self-burrowing seismic-sensing tool that includes a navigator, implemented by a processor, configured to determine a course to a target destination within a subsurface formation, the course being based on a current location received from one or more sensors, a burrower, implemented by the processor, configured to operate a burrowing device to reach the target destination based on the course, and a data acquisition unit, implemented by the processor, configured to generate seismic data based on seismic waves received at the target destination.

B. A computer-implemented method for a self-burrowing seismic-sensing tool including the steps of determining a course to a target destination within a subsurface formation from a surface location, operating a burrowing device to the target destination based on the course, and generating seismic data based on seismic waves received at the target destination.

C. A computer-readable medium storing computer-executable instructions, which, when executed by a processor, causes the processor to perform steps to determine a course to a target destination within a subsurface formation, the course based on a current location received from one or more sensors, operate a burrowing device to the target destination based on the course, and collect seismic data based on seismic waves received at the target destination.

Each of embodiments A, B, and C may have one or more of the following additional elements in any combination: Element 1: further comprising a command unit, implemented by the processor, configured to receive one or more commands or operational errors and to determine one or more operation modes based upon the one or more commands or operational errors. Element 2: wherein the burrower causes the burrowing device to descend within the subsurface formation in response to the one or more operation modes indicating descent, and wherein the burrower causes the burrowing device to ascend within the subsurface formation in response to the one or more operation modes indicating ascent. Element 3: wherein the data acquisition unit acquires data in response to the one or more operation modes indicating to begin seismic data acquisition, and wherein the data acquisition unit ceases acquiring data in response to the one or more operation modes indicating to cease seismic data acquisition. Element 4: wherein the command unit causes a transceiver to transmit a signal in response to the one or more operation modes indicating the self-burrowing seismic-sensing tool is waiting for retrieval. Element 5: further comprising a wireless communication unit configured to facilitate underground communication with wireless communication units of adjacent self-burrowing seismic-sensing tools.

Element 6: further comprising receiving an indication to cease collection of the seismic data, and ascending from the target destination to the surface location. Element 7: further comprising descending from the surface location to the target destination via a first course, and ascending from the target destination to the surface location via a second course, wherein the first course and the second course are different courses. Element 8: further comprising receiving an indication of an operational error, determining that the operational error indicates a navigational error, and performing a maneuver to correct for the navigational error. Element 9: further comprising determining that the operational error indicates a system error, determining one or more measurements between a current location and the surface location, and determining the second course to navigate from the current location to the surface location. Element 10: further comprising determining one or more measurements between the surface location and the target destination, and determining the course based upon the one or more measurements. Element 11: further comprising determining a current location within the subsurface formation at periodic intervals, comparing the current location determined at each periodic interval to the course, and re-positioning the burrowing device based on the comparison indicating that the current location deviates from the course by a specified threshold. Element 12: further comprising comparing the current location determined at each interval to the target destination, ceasing descent based on the comparison indicating that the current location is the target destination, and triggering collection of the seismic data. Element 13: further comprising determining one or more measurements between the target destination and the surface location, determining a second course to navigate from the target destination to the surface location, and ascending from the target destination to the surface location based on the second course. Element 14: further comprising comparing the current location determined at each interval to the second course, and re-positioning based on the comparison indicating that the current location deviates from the second course by the specified threshold. Element 15: further comprising comparing the current location determined at each interval to the surface location, ceasing ascent based on the comparison indicating that the current location is the surface location, and triggering retrieval of the self-burrowing seismic-sensing tool. Element 16: further comprising receiving the target destination, and navigating to a delivery site associated with the target destination.

Element 17: wherein the processor is further operable to determine one or more operation modes based upon one or more commands or operational errors received, cause the burrowing device to descend in response to the one or more operation modes indicating descent, cause the burrowing device to ascend in response to the one or more operation modes indicating ascent, and cause a transceiver to transmit a signal in response to the one or more operation modes indicating that a self-burrowing seismic-sensing tool is waiting for retrieval.

By way of non-limiting example, exemplary combinations applicable to A, B, and C include: Element 1 with Element 2; Element 1 with Element 3; Element 1 with Element 4; Element 6 with Element 7; Element 7 with Element 8; Element 7 with Element 9; Element 10 with Element 11; Element 11 with Element 12; Element 12 with Element 13; Element 13 with Element 14; and Element 14 with Element 15.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, blocks, operations, elements, and/or components, but do not preclude the presence or addition of one or more other features, integers, blocks, operations, elements, components, and/or groups thereof.

Terms of orientation are used herein merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, as used herein, the terms “coupled” or “coupled to” or “connected” or “connected to” or “attached” or “attached to” may indicate establishing either a direct or indirect connection, and is not limited to either unless expressly referenced as such.

While the description has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the description without departing from the essential scope thereof. Therefore, it is intended that the invention not be limited to the particular embodiments described, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

What is claimed is:

1. A self-burrowing seismic-sensing tool, comprising:
a navigator, implemented by a processor, configured to determine a course to a target destination within a subsurface formation, the course being based on a current location received from one or more sensors;
a burrower, implemented by the processor, configured to operate a burrowing device to reach the target destination based on the course; and
a data acquisition unit, implemented by the processor, configured to generate seismic data based on seismic waves received at the target destination.

2. The self-burrowing seismic-sensing tool of claim 1, further comprising a command unit, implemented by the processor, configured to receive one or more commands or operational errors and to determine one or more operation modes based upon the one or more commands or operational errors.

3. The self-burrowing seismic-sensing tool of claim 2, wherein the burrower causes the burrowing device to descend within the subsurface formation in response to the one or more operation modes indicating descent, and wherein the burrower causes the burrowing device to ascend within the subsurface formation in response to the one or more operation modes indicating ascent.

4. The self-burrowing seismic-sensing tool of claim 2, wherein the data acquisition unit acquires data in response to the one or more operation modes indicating to begin seismic data acquisition, and wherein the data acquisition unit ceases acquiring data in response to the one or more operation modes indicating to cease seismic data acquisition.

5. The self-burrowing seismic-sensing tool of claim 2, wherein the command unit causes a transceiver to transmit a signal in response to the one or more operation modes indicating the self-burrowing seismic-sensing tool is waiting for retrieval.

6. The self-burrowing seismic-sensing tool of claim 1, further comprising a wireless communication unit configured to facilitate underground communication with wireless communication units of adjacent self-burrowing seismic-sensing tools.

7. A computer-implemented method for a self-burrowing seismic-sensing tool, comprising:
determining a course to a target destination within a subsurface formation from a surface location;
operating a burrowing device to the target destination based on the course; and
generating seismic data based on seismic waves received at the target destination.

8. The computer-implemented method of claim 7, further comprising:
receiving an indication to cease collection of the seismic data; and
ascending from the target destination to the surface location.

9. The computer-implemented method of claim 8, further comprising:
descending from the surface location to the target destination via a first course; and
ascending from the target destination to the surface location via a second course, wherein the first course and the second course are different courses.

10. The computer-implemented method of claim 9, further comprising:
receiving an indication of an operational error;
determining that the operational error indicates a navigational error; and
performing a maneuver to correct for the navigational error.

11. The computer-implemented method of claim 9, further comprising:
determining that the operational error indicates a system error;
determining one or more measurements between a current location and the surface location; and
determining the second course to navigate from the current location to the surface location.

12. The computer-implemented method of claim 7, further comprising:
determining one or more measurements between the surface location and the target destination; and
determining the course based upon the one or more measurements.

13. The computer-implemented method of claim 12, further comprising:
determining a current location within the subsurface formation at periodic intervals;
comparing the current location determined at each periodic interval to the course; and
re-positioning the burrowing device based on the comparison indicating that the current location deviates from the course by a specified threshold.

14. The computer-implemented method of claim 13, further comprising:
comparing the current location determined at each interval to the target destination;
ceasing descent based on the comparison indicating that the current location is the target destination; and
triggering collection of the seismic data.

15. The computer-implemented method of claim 14, further comprising:
determining one or more measurements between the target destination and the surface location;
determining a second course to navigate from the target destination to the surface location; and
ascending from the target destination to the surface location based on the second course.

16. The computer-implemented method of claim 15, further comprising:
comparing the current location determined at each interval to the second course; and
re-positioning based on the comparison indicating that the current location deviates from the second course by the specified threshold.

17. The computer-implemented method of claim 16, further comprising:
comparing the current location determined at each interval to the surface location;
ceasing ascent based on the comparison indicating that the current location is the surface location; and
triggering retrieval of the self-burrowing seismic-sensing tool.

18. The computer-implemented method of claim 7, further comprising:
receiving the target destination; and
navigating to a delivery site associated with the target destination.

19. A computer-readable medium storing computer-executable instructions, which, when executed by a processor, causes the processor to:
determine a course to a target destination within a subsurface formation, the course based on a current location received from one or more sensors;
operate a burrowing device to the target destination based on the course; and
collect seismic data based on seismic waves received at the target destination.

20. The computer-readable medium of claim 19, wherein the processor is further operable to:
determine one or more operation modes based upon one or more commands or operational errors received;
cause the burrowing device to descend in response to the one or more operation modes indicating descent;
cause the burrowing device to ascend in response to the one or more operation modes indicating ascent; and
cause a transceiver to transmit a signal in response to the one or more operation modes indicating that a self-burrowing seismic-sensing tool is waiting for retrieval.
